(19) United States
(12) Patent Application Publication
(10) Pub. No.: US 2014/0286151 A1
(43) Pub. Date: Sep. 25, 2014

(54) OPTICAL PICKUP AND DISC DEVICE

(71) Applicant: Funai Electric Co., Ltd., Osaka (JP)

(72) Inventors: Mika HAMAOKA, Daito-shi (JP); Mio KOGA, Daito-shi (JP); Mitsuyoshi SASABE, Daito-shi (JP)

(73) Assignee: Funai Electric Co., Ltd., Osaka (JP)

(21) Appl. No.: 14/202,427

(22) Filed: Mar. 10, 2014

(30) Foreign Application Priority Data
Mar. 22, 2013 (JP) 2013-059929

(51) Int. Cl. G11B 7/085

(52) U.S. Cl. CPC G11B 7/08541
USPC 369/53.29

(57) ABSTRACT

An optical pickup includes a plurality of light sources, an objective lens, a diffractive optical element, and a light-detecting unit. The various light sources emit light of wavelengths that are different from each other. The objective lens focuses light on an optical disc. The diffractive optical element includes a diffracting portion and a light-blocking portion. The diffracting portion diffracts return light reflected from a first recording layer of the optical disc where information is being read or written. The light-blocking portion blocks stray light reflected from a second recording layer of the optical disc that is different from the first recording layer. The light-detecting unit receives the diffracted light of the diffractive optical element and generates an output signal to generate a tracking error signal based on this diffracted light. Furthermore, the light-blocking portion includes a plurality of light-blocking patterns which block light of wavelengths that are different from each other.

### BACKGROUND OF THE INVENTION

1. Field of the Invention

The present invention relates to an optical pickup that is used when reading information recorded on optical discs and writing information to optical discs, as well as to a disc device equipped with this optical pickup.

2. Description of the Related Art

Optical pickups for reading and writing information to and from optical discs such as Blu-Ray (registered trademark) discs (BDs), digital versatile discs (DVDs) and compact discs (CDs) have been known. These optical pickups use objective lenses to focus light emitted from a light source onto the recording layer of the optical disc.

When an optical pickup is used to read or write information from or to an optical disc, it is necessary to perform tracking control so as to make an optical spot, focused on the recording layer by an objective lens, constantly follow tracks formed on the optical disc. Because of this, the optical pickup calculates a tracking error signal which expresses the amount of deviation between the optical spot and the target track based on signals output from a light detector. Then, control that shifts the position of the objective lens in the tracking direction (tracking control) is performed based on the tracking error signal.

Push-Pull (PP), Differential Push-Pull (DPP), and the like have been known in the past as methods for calculating tracking error signals. The DPP method, in particular, has been widely used in conventional optical pickups because it allows the tracking error signal to be obtained by suppressing the effects of an offset component arising due to lens shift in the tracking direction of the objective lens. However, the DPP method uses a diffraction grating to split the light emitted from the light source into three beams composed of a main beam and two auxiliary beams and direct these light beams onto the optical disc. Therefore, light is utilized less efficiently than with the PP method, for example. Furthermore, the configuration of the optical pickup also becomes more complex.

In order to ameliorate these points, optical pickups have been developed which are used to obtain tracking error signals by methods that have simpler configurations and greater light utilization efficiency than the DPP method. With the optical pickup of International Laid-Open Publication No. 2011/086951, for example, part of the 0th order light and ±1st order light of the reflected light from the optical disc is diffracted in the main diffraction region of a diffractive optical element, and the other part of the 0th order light is diffracted in auxiliary diffraction regions. The main light-receiving unit of the light-detecting unit receives the respective 0th order diffracted lights from the main diffraction region and auxiliary diffraction regions and generates the main push-pull signal. The auxiliary light-receiving unit receives the respective ±1st order diffracted lights from the auxiliary diffraction regions and generates the auxiliary push-pull signal. Then, the tracking error signal is generated by removing the amplified auxiliary push-pull signal from the main push-pull signal.

However, the structure of the optical disc varies with its type (number of recording layers, format, etc.). For example, besides a single-layer type that has a single recording layer, the optical disc includes a multilayer type that has a plurality of recording layers. When information is read from or written to a multilayer-type optical disc, light reflected by recording layer(s) other than the recording layer where the read or write processing is being performed enters the light detector as stray light. When the light detector receives this stray light, an offset component arising due to the stray light is generated in the tracking error signal, so it becomes impossible to obtain a good tracking error signal.

International Laid-Open Publication No. 2011/086951 responds to such a problem by installing rectangular light-blocking regions on the two outer sides of two rectangular auxiliary diffraction regions provided sandwiching the main diffraction region in the diffractive optical element, thereby reducing the stray light entering the light detector. However, some of the stray light from the recording layer(s) closer to the light-entering surface of the optical disc than the recording layer where information is being read or written can be blocked in these light-blocking regions, but stray light from the recording layer(s) more distant from the light-entering surface cannot be blocked. Accordingly, the generation in the tracking error signal of an offset component arising due to stray light cannot be adequately prevented in International Laid-Open Publication No. 2011/086951.

Moreover, when the format of the optical disc (BD, DVD, CD, or the like) changes, the amount of stray light entering the light detector also changes. Therefore, stray light can no longer be adequately blocked in International Laid-Open Publication No. 2011/086951 when the format of the optical disc changes, and the generation of the offset component arising due to stray light can no longer be adequately prevented. Alternatively, blocking of stray light can also block the light required to generate the tracking error signal, resulting in the risk of degrading the quality of the tracking error signal.

### SUMMARY OF THE INVENTION

Accordingly, preferred embodiments of the present invention provide an optical pickup and a disc device which prevent the generation of an offset component arising due to stray light, thus allowing a good tracking error signal to be obtained.

An optical pickup according to a preferred embodiment of the present invention includes a plurality of light sources which emit light of wavelengths that are different from each other; an objective lens which focuses the light on an optical disc; a diffractive optical element which includes a diffracting portion that diffracts return light reflected from a first recording layer of the optical disc where information is being read or written and a light-blocking portion that blocks stray light reflected from a second recording layer of the optical disc that is different from the first recording layer; and a light-detecting unit which receives the diffracted light of the diffractive optical element and generates an output signal to generate a tracking error signal based on this diffracted light, wherein the light-blocking portion includes a plurality of light-blocking patterns which block light of wavelengths that are different from each other.

With this configuration, the light-blocking portion of the diffractive optical element preferably includes a plurality of light-blocking patterns which block light of wavelengths that are different from each other. For this reason, stray light is blocked by the light-blocking pattern that corresponds to the wavelength of the stray light and does not enter the light detector, but the light required to generate the tracking error signal does enter the light detector. Accordingly, it is possible to prevent a decline in the quality of the tracking error signal caused by the light-blocking pattern. Consequently, generation of the offset component arising due to stray light is prevented, thus making it possible to obtain a good tracking error signal.

In the configuration, furthermore, the respective light-blocking rates of the plurality of light-blocking patterns may vary according to the wavelength of light that enters the diffractive optical element.

For example, this configuration allows the light entering the diffractive optical element to be blocked by the light-blocking pattern that corresponds to the wavelength of the stray light but not to be blocked by the other light-blocking pattern(s) corresponding to other wavelengths. Accordingly, it is possible to prevent the light required to generate the tracking error signal from being blocked by other light-blocking pattern(s).

In the configuration, the respective light-blocking rates of the plurality of light-blocking patterns may be different from each other.

With this configuration, blocking of the light required to generate the tracking error signal by the light-blocking pattern(s) is suppressed.

In another preferred embodiment of the present invention, a disc device includes an optical pickup according to one of the preferred embodiments of the present invention described above.

With this configuration, the light-blocking portion of the diffractive optical element includes a plurality of light-blocking patterns which block light of wavelengths that are different from each other. As a result, stray light is blocked by the light-blocking pattern that corresponds to the wavelength of the stray light and does not enter the light detector, but the light required to generate the tracking error signal does enter the light detector. Therefore, decline in the quality of the tracking error signal caused by the light-blocking pattern is prevented. Accordingly, it is possible to prevent the generation of the offset component arising due to stray light and therefore to obtain a good tracking error signal.

With various preferred embodiments of the present invention, it is possible to provide an optical pickup and a disc device with which the generation of an offset component arising due to stray light is prevented, thus making it possible to obtain a good tracking error signal.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a configuration diagram of the optical pickup according to a preferred embodiment of the present invention.

FIG. 2 is a schematic plan view showing the disposition of the first and second objective lenses relative to the optical disc.

FIG. 3A is a schematic plan view showing the state of the return light of BD laser light that enters the hologram element.

FIG. 3B is a sectional view showing one example of return light reflected from the recording layers of a three-layer-type BDXL.

FIG. 4A is a schematic plan view showing the state of the return light of DVD laser light that enters the hologram element.

FIG. 4B is a sectional view showing one example of return light reflected from the recording layers of a two-layer-type DVD.

FIG. 5 is a schematic plan view showing an exemplary configuration of the hologram element according to a preferred embodiment of the present invention.

FIG. 6 is a schematic plan view showing another exemplary configuration of the hologram element according to a preferred embodiment of the present invention.

FIG. 7 is a schematic plan view showing another exemplary configuration of the hologram element according to a preferred embodiment of the present invention.

FIG. 8 is a schematic plan view showing an exemplary configuration of the photodetector according to a preferred embodiment of the present invention.

FIG. 9A is a schematic plan view showing the hologram element of Comparative Example 1.

FIG. 9B is a schematic plan view showing the light reception pattern of the photodetector for a three-layer-type BDXL in Comparative Example 1.

FIG. 10A is a schematic plan view showing the hologram element of Comparative Example 2.

FIG. 10B is a schematic plan view showing the light reception pattern of the photodetector for a two-layer-type DVD in Comparative Example 2.

FIG. 11A is a schematic plan view showing the light reception pattern of the photodetector for a three-layer-type BDXL in Working Example 1 according to a preferred embodiment of the present invention.

FIG. 11B is a schematic plan view showing the hologram element of Working Example 1.

FIG. 12A is a schematic plan view showing the light reception pattern of the photodetector for a two-layer-type DVD in Working Example 2 according to a preferred embodiment of the present invention.

FIG. 12B is a schematic plan view showing the hologram element of Working Example 2.

### DETAILED DESCRIPTION OF THE PREFERRED EMBODIMENTS

Preferred embodiments of the present invention will be described below with reference to the drawings. The optical pickup 1 according to a preferred embodiment of the present invention is a device for performing read processing and/or write processing of information from and to an optical disc D. The optical pickup 1 is provided on a disc device such as a BD recorder, DVD recorder, BD player, and DVD player. Examples of types of the optical disc D that can be used in the optical pickup 1 include BD (Blu-ray disc) or DVD (digital versatile disc) of a single-layer type or double-layer type, BDXL (registered trademark) including three or more recording layers, and CD (compact disc).

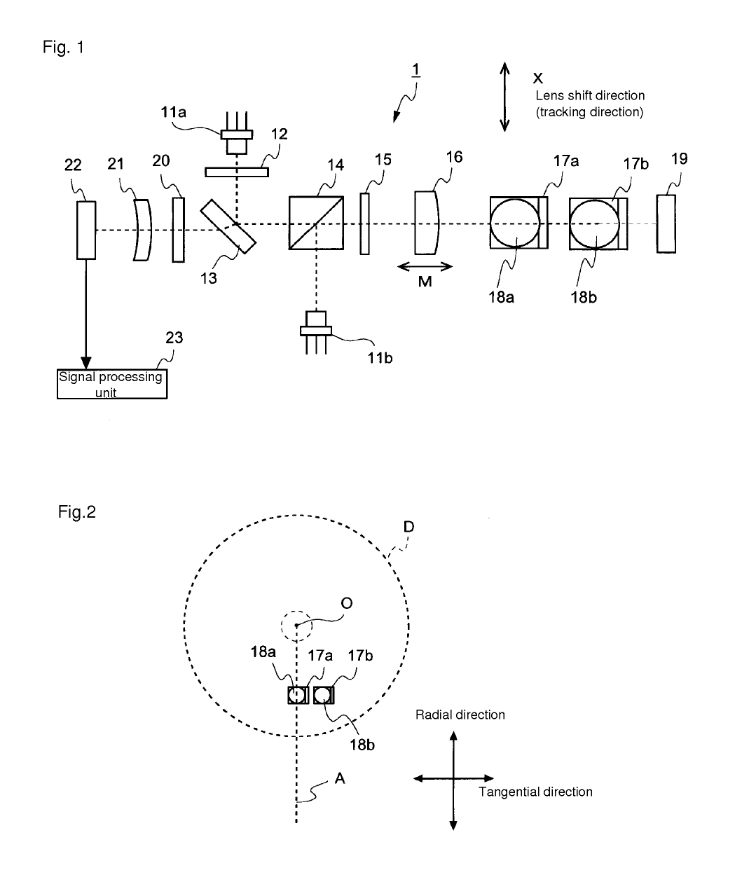

FIG. 1 is a configuration diagram of the optical pickup of the present preferred embodiment. The optical pickup of the present preferred embodiment, as shown in FIG. 1, includes a first semiconductor laser element 11a, a second semiconductor laser element 11b, a half-wave plate 12, a beam splitter 13, a polarization beam splitter 14, a quarter-wave plate 15, a collimating lens 16, a first rising mirror 17a, a second rising mirror 17b, a first objective lens 18a, a second objective lens 18b, a front monitor photodetector 19, a hologram element 20, a cylindrical lens 21, a photodetector 22, and a signal processing unit 23.

The first semiconductor laser element 11a is a first light source that emits laser light for DVDs and emits laser light at a wavelength band of 661 nm, for example. The second semiconductor laser element 11b is a second light source that emits laser light for BDs and emits laser light at a wavelength band of 405 nm, for example.

The half-wave plate 12 converts the S-polarized light (or P-polarized light) of DVD laser light into P-polarized light (or S-polarized light). The beam splitter 13 reflects a portion of the entering laser light and transmits the other portion.

The polarization beam splitter 14 reflects the S-polarized light (or P-polarized light) of the entering laser light and transmits the P-polarized light (or S-polarized light). Note that the polarization beam splitter 14 preferably is an optical member that works on BD laser light; DVD laser light is transmitted regardless of its polarization state (whether it is S-polarized light or P-polarized light). The quarter-wave plate 15 converts linearly polarized laser light (S polarized light or P polarized light) into circularly polarized light and converts circularly polarized light into linearly polarized light.

The collimating lens 16 is provided so as to be movable in the direction of the optical axis of the laser light (left-right direction M in FIG. 1) in order to enable changes in the convergence/divergence state of the laser light. The position of the collimating lens 16 is moved appropriately according to the type of optical disc D, the layer jump, and so on. The optical pickup 1 thus adequately suppresses spherical aberration effects.

The first and second rising mirrors 17a and 17b are dichroic mirrors. The first rising mirror 17a reflects DVD laser light that has passed through the collimating lens 16 toward the first objective lens 18a. Note that the first rising mirror 17a is configured to enable BD laser light to pass through. The second rising mirror 17b reflects BD laser light that has passed through the collimating lens 16 and the first rising mirror 17a toward the second objective lens 18b.

The first objective lens 18a is disposed above the first rising mirror 17a and focuses DVD laser light entering from the first rising mirror 17a onto a recording layer of the optical disc D. Furthermore, the second objective lens 18b is disposed above the second rising mirror 17b and focuses BD laser light entering from the second rising mirror 17b onto a recording layer of the optical disc D.

FIG. 2 is a schematic plan view showing the disposition of the first and second objective lenses relative to the optical disc. The first and second objective lenses 18a and 18b are disposed in a parallel configuration in the tangential direction of the optical disc D as shown in FIG. 2. Note that the tangential direction refers to a substantially tangential direction to the tracks in a concentric circular form or spiral form that are provided on the recording layer of the optical disc D. In the planar view seen from the direction normal to the main plane of the optical disc D, the first objective lens 18a is disposed in a position that places its center on datum plane A passing through the rotational center O of the optical disc D. Moreover, the second objective lens 18b is disposed in a position shifted in the tangential direction from the datum plane A. Note that the datum plane A is perpendicular to the main plane of the optical disc D as well as parallel to the radial direction of the optical disc D. The radial direction is a direction substantially perpendicular to the tangential direction. The first and second objective lenses 18a and 18b are driven (shifted) in the radial direction during tracking control. For this reason, the lens shift directions X of the first and second objective lenses 18a and 18b are substantially parallel to the radial direction.

The front monitor photodetector 19 is a light-detecting unit that detects the laser power of laser light emitted from the first and second semiconductor laser elements 11a and 11b; it generates a photoelectric conversion signal from the DVD or BD laser light it receives. The laser power of the first and second semiconductor laser elements 11a and 11b is controlled by the control unit (not shown) based on this photoelectric conversion signal.

The hologram element 20 is a diffractive optical element that diffracts light reflected at the recording layer of the optical disc D. Note that the reflected light of each laser light reflected by the optical disc D will be referred to as “return light” below. The configuration of this hologram element 20 will be described in detail later.

The cylindrical lens 21 is a sensor lens provided with a cylindrical surface in order to obtain a focus error signal by the astigmatic method from the return light of the DVD or BD laser light. Diffracted light diffracted at the hologram element 20 enters the photodetector 22 via the cylindrical lens 21.

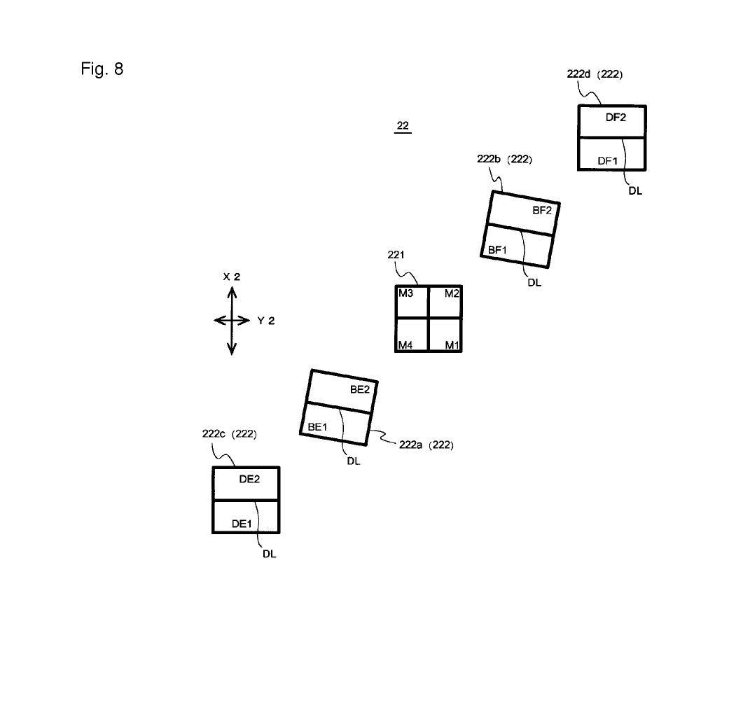

The photodetector 22 is a light-detecting unit which functions as a photoelectric conversion device that receives the diffracted light of the hologram element 20 and converts the received optical signal (diffracted light) to an electrical signal (a photoelectric conversion signal). The photodetector is configured (see FIG. 8 which will be described later) preferably includes a main light-receiving unit 221 and four auxiliary light-receiving units 222 (first through fourth auxiliary light-receiving units 222a through 222d). Note that the configuration of the photodetector 22 will be described in detail later. The photoelectric conversion signal that is output from the photodetector 22 is sent to the signal processing unit 23.

The signal processing unit 23 generates replay signals, focus error signals, tracking error signals TE, and the like based on the output signals (such as a main light-receiving unit signal or auxiliary light-receiving unit signal which will be described later) of the photodetector 22. Note that the focus error signal and the tracking error signal TE generated by the signal processing unit 23 are output to the control unit (not shown) of the optical pickup 1. The control unit (not shown) of the optical pickup 1 causes the actuator (not shown) to drive the first and second objective lenses 18a and 18b so as to perform focusing control and tracking control based on the focus error signal and the tracking error signal TE.

The optical pickup 1 configured as shown in FIG. 1 creates optical paths that guide laser light emitted from the first and second semiconductor laser elements 11a and 11b to the optical disc D and also guide return light reflected by the optical disc D to the photodetector 22. The optical path of each laser light will be described below.

First, the optical path for BDs will be described. BD laser light is emitted from the second semiconductor laser element 11b, and the S-polarized light (or P-polarized light) of the BD laser light is reflected at the polarization beam splitter 14. The reflected S-polarized light is converted to circularly polarized light by the quarter-wave plate 15. The converted circularly polarized light passes through the collimating lens 16 and the first rising mirror 17a and is then reflected by the second rising mirror 17b. The circularly polarized light reflected by the second rising mirror 17b is focused by the second objective lens 18b onto the recording layer of the optical disc D (BD). The focused circularly polarized light is reflected by the recording layer and passes through the first objective lens 18a as return light Ra. The return light Ra is then reflected by the second rising mirror 17b and passes through the first rising mirror 17a and the collimating lens 16, after which it is converted by the quarter-wave plate 15 from circularly polarized light to linearly polarized light (S-polarized light or P-polarized light). The converted return light Ra passes through the polarization beam splitter 14 and the beam splitter 13 and then arrives at the photodetector 22 via the sensor optical system including the hologram element 20 and the cylindrical lens 21.

Next, the optical path for DVDs will be described. DVD laser light is emitted from the first semiconductor laser element 11a, and the S-polarized light of the DVD laser light is converted to P-polarized light by the half-wave plate 12. This P-polarized light is reflected at the beam splitter 13, passes through the polarization beam splitter 14, and is then converted to circularly polarized light by the quarter-wave plate 15. The converted circularly polarized light passes through the collimating lens 16 and is then reflected by the first rising mirror 17a. The circularly polarized light reflected by the first rising mirror 17a is focused by the first objective lens 18a onto the recording layer of the optical disc D (DVD). The focused circularly polarized light is reflected by the recording layer and passes through the first objective lens 18a as return light Rb. The return light Rb is then reflected by the first rising mirror 17a and passes through the collimating lens 16, after which it is converted by the quarter-wave plate 15 from circularly polarized light to linearly polarized light (S-polarized light or P-polarized light). The converted return light Rb passes through the polarization beam splitter 14 and the beam splitter 13 and then arrives at the photodetector 22 via the sensor optical system including the hologram element 20 and the cylindrical lens 21.

Thus, the BD and DVD optical paths share the polarization beam splitter 14, the quarter-wave plate 15, the collimating lens 16, and the first rising mirror 17a on the outward paths that guide the respective laser lights to the optical disc D. In addition, the return paths of the return lights Ra and Rb of the respective laser lights to the photodetector 22 share the first rising mirror 17a, the collimating lens 16, the quarter-wave plate 15, the polarization beam splitter 14, the beam splitter 13, the hologram element 20, and the cylindrical lens 21.

Next, the return lights Ra and Rb of the respective laser lights that enter the hologram element 20 will be described. The tracks are provided on the recording layers of the optical disc D in a concentric circular form or a spiral form. These tracks act on light entering the optical disc D as diffraction gratings. Therefore, the return lights Ra and Rb reflected by the recording layers of the optical disc D are split into 0th order light, ±1st order light, and the like and then enter the hologram element 20.

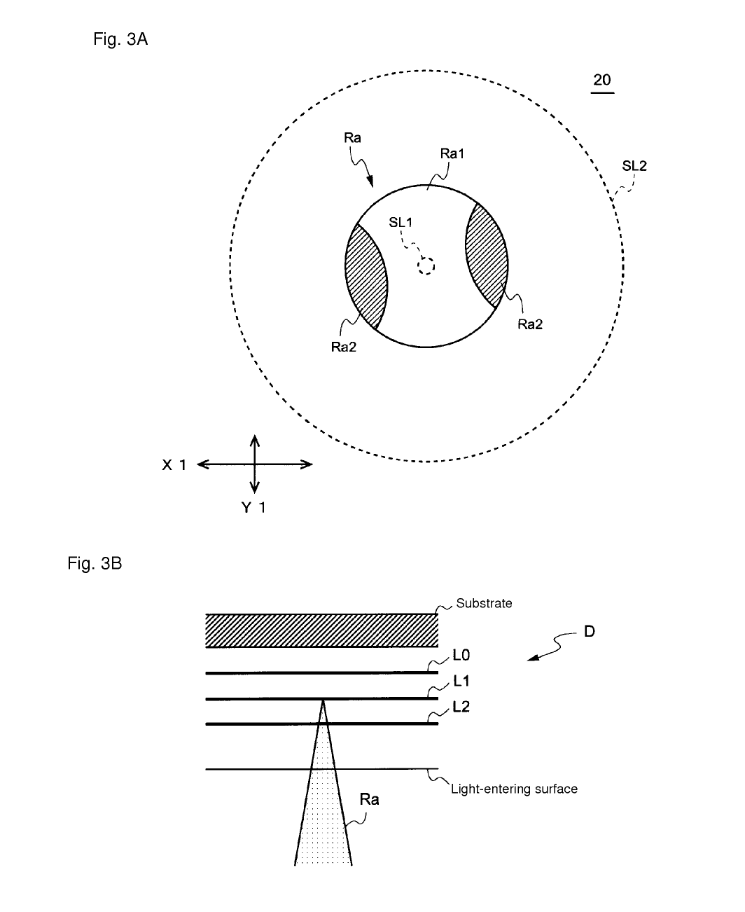

First, the return light Ra of BD laser light will be described. FIG. 3A is a schematic plan view showing the state of the return light of BD laser light that enters the hologram element. Furthermore, FIG. 3B is a sectional view showing one example of return light reflected from the recording layers of a three-layer-type BDXL. FIG. 3A is a diagram that envisions BD laser light being focused on the recording layer L1 of a three-layer BDXL as shown in FIG. 3B. Moreover, as shown in FIG. 3B, the respective recording layers provided on the substrate of a three-layer BDXL will be called L0, L1, and L2, moving in order from the recording layer provided closest to the side of the substrate toward the light-entering surface. In the example of FIG. 3B, laser light is focused on the recording layer L1 of the BDXL, so the recording layer L1 is an example of the first recording layer, while the recording layers L0 and L2 are examples of the second recording layer. Note that if laser light is focused on the recording layer L0 of the BDXL, the recording layer L0 becomes an example of the first recording layer, while the recording layers L1 and L2 become examples of the second recording layer. In addition, if laser light is focused on the recording layer L2 of the BDXL, the recording layer L2 becomes an example of the first recording layer, while the recording layers L0 and L1 become examples of the second recording layer.

In the return light Ra that enters the hologram element 20, a portion of the 0th order light overlaps the ±1st order light as shown in FIG. 3A. Below, the light beam where the 0th order light and the ±1st order light do not overlap in the return light Ra will be referred to as “first return light Ra1,” and the light beam where the 0th order light and the ±1st order light overlap will be called “second return light Ra2.” A first return light Ra1 and two second return lights Ra2 enter the hologram element 20.

The first return light Ra1 in the center of the return light Ra (the portion sandwiched by the two shaded portions in FIG. 3A) is the light beam that includes 0th order light but does not include ±1st order light; it is the region that exhibits an amount of light dependent on the reflectance of the optical disc D. In other words, this light beam does not contain an AC signal (track traverse signal) component that is generated when light entering the optical disc D traverses a track, and it corresponds to a light beam that contains an offset component arising due to shift or the like of the second objective lens 18b, for example. Meanwhile, the two second return lights Ra2 on the two end portions of the center of the return light Ra (the shaded portions in FIG. 3A) are light beams that include 0th order light and ±1st order light; they correspond to the light beams that include the track traverse signal component.

Note that in FIG. 3A, the return light Ra (especially the second return lights Ra2) is inclined in the leftward rotation (counterclockwise) with respect to the direction X1, which corresponds to the lens shift direction X; this is because the second objective lens 18b is disposed at a position shifted in the tangential direction from the datum plane A which passes through the rotational center O of the optical disc D (see FIG. 2). Furthermore, in FIG. 3A, the direction X1 is the direction in which the return light Ra moves on the light-entering surface of the hologram element 20 when the second objective lens 18b is moved (shifted) in the tracking direction (lens shift direction X).

Moreover, the BD laser light focused on the recording layer L1 of the three-layer BDXL is reflected not only at the recording layer L1 but also at the recording layer L0 and the recording layer L2. These reflected lights enter the hologram element 20 as stray light. Below, stray light that enters the hologram element 20 from the recording layer L0 provided at a position farther from the light-entering surface of the BDXL (i.e., on the substrate side) than the recording layer L1 on which laser light is focused will be referred to as “first stray light SL1.” In addition, stray light that enters the hologram element 20 from the recording layer L2 provided at a position closer to the light-entering surface of the BDXL (i.e., on the light-entering surface side) than the recording layer L1 will be referred to as “second stray light SL2.”

As shown in FIG. 3A, the first stray light SL1 enters the light-entering surface of the hologram element 20 at a region which includes the position that intersects the optical axis of the return light Ra and which is also a portion of the entering region of the first return light Ra1 reflected from the recording layer L1. Furthermore, the second stray light SL2 enters the light-entering surface of the hologram element 20 at a region which entirely includes the region where the return light Ra reflected from the recording layer L1 enters.

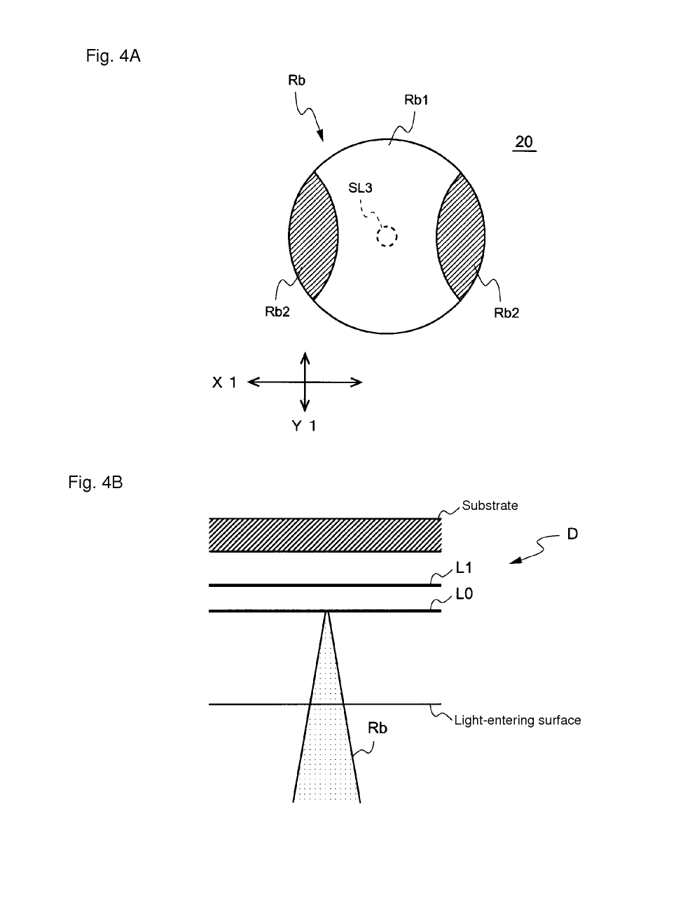

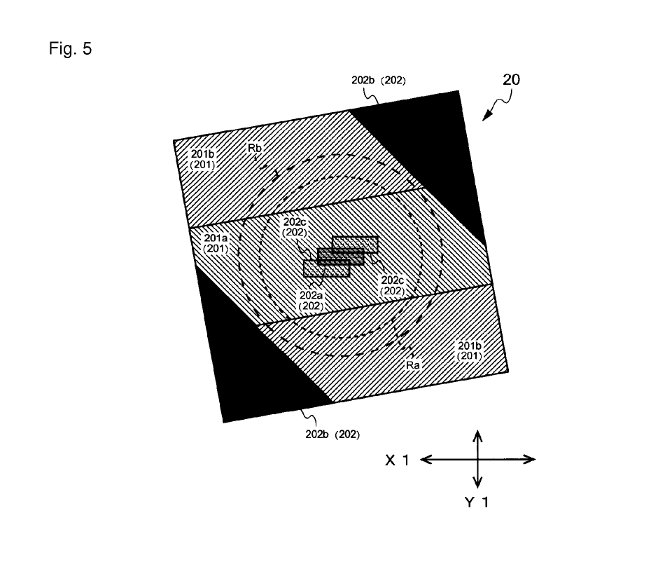

Next, the return light Rb of DVD laser light will be described. FIG. 4A is a schematic plan view showing the state of the return light of DVD laser light that enters the hologram element. Moreover, FIG. 4B is a sectional view showing one example of return light reflected from the recording layers of a two-layer-type DVD. FIG. 4A is a diagram that envisions DVD laser light being focused on the recording layer L0 of a two-layer DVD as shown in FIG. 4B. Note that in a two-layer DVD, opposite to the case of a BD, the respective recording layers provided on the substrate thereof will be referred to as L0 and L1, moving in order toward the substrate from the recording layer provided closest to the side of the light-entering surface. In the example of FIG. 4B, laser light is focused on the recording layer L0 of the DVD, so the recording layer L0 is an example of the first recording layer, while the recording layer L1 is an example of the second recording layer. Note that if laser light is focused on the recording layer L1 of the optical disc D, the recording layer L1 becomes an example of the first recording layer, while the recording layer L0 becomes an example of the second recording layer.

As shown in FIG. 4A, the return light Rb of the DVD laser light that enters the hologram element 20 preferably is configured similarly to the return light Ra (FIG. 3A). Below, in the return light Rb, the light beam where the 0th order light and the ±1st order light do not overlap (the portion sandwiched by the two shaded portions in FIG. 4A) will be referred to as “first return light Rb1.” In addition, the light beam where 0th order light and ±1st order light overlap (the shaded portions in FIG. 4A) will be referred to as “second return light Rb2.”

However, the return light Rb (especially the second return lights Rb2) is not inclined with respect to the direction X1. This is because the first objective lens 18a is disposed on the datum plane A which passes through the rotational center O of the optical disc D (see FIG. 2). Furthermore, in FIG. 4A, the direction X1 is the direction in which the return light Rb moves on the light-entering surface of the hologram element 20 when the first objective lens 18a is moved (shifted) in the tracking direction (lens shift direction X).

Moreover, the DVD laser light focused on the recording layer L0 of the two-layer DVD is reflected not only by the recording layer L0 but also by the recording layer L1 and enters the hologram element 20 as stray light. Below, stray light that enters the hologram element 20 from the recording layer L1 provided at a position farther from the light-entering surface of the DVD (i.e., on the substrate side) than the recording layer L0 on which the DVD laser light is focused will be referred to as “third stray light SL3.” As shown in FIG. 4A, the third stray light SL3 enters the light-entering surface of the hologram element 20 at a region which includes the position that intersects the optical axis of the return light Rb and which is also a portion of the entering region of the first return light Rb1 reflected from the recording layer L0.

Note that if DVD laser light is focused on the recording layer L1 of the two-layer DVD, stray light is reflected from the recording layer L0, the opposite of the case of FIG. 4B. As it happens, the stray light in this case has an extremely small intensity compared to the first stray light SL1 and second stray light SL2 produced in the cases of FIG. 3A and FIG. 3B or the third stray light SL3 produced in the cases of FIG. 4A and FIG. 4B, and it also has very little effect on the tracking error signal TE. Therefore, description of stray light reflected from the recording layer L0 is omitted in the present preferred embodiment.

Next, the hologram element 20 will be described in detail. FIG. 5 is a schematic plan view showing an exemplary configuration of the hologram element of the present preferred embodiment. As shown in FIG. 5, the hologram element 20 includes diffracting portions 201 and light-blocking portions 202. The diffracting portions 201 are regions on which are formed diffraction patterns to diffract the return lights Ra and Rb from the optical disc D and cause this diffracted light to enter the light-receiving plane of the photodetector 22. These diffracting portions 201 are configured by including a first diffracting portion 201a and two second diffracting portions 201b. The diffraction patterns provided in the first and second diffracting portions 201a and 201b are formed, for example, by using a relief grating including rectangular diffraction grooves, a blazed grating composed of sawtooth diffraction grooves, or the like.

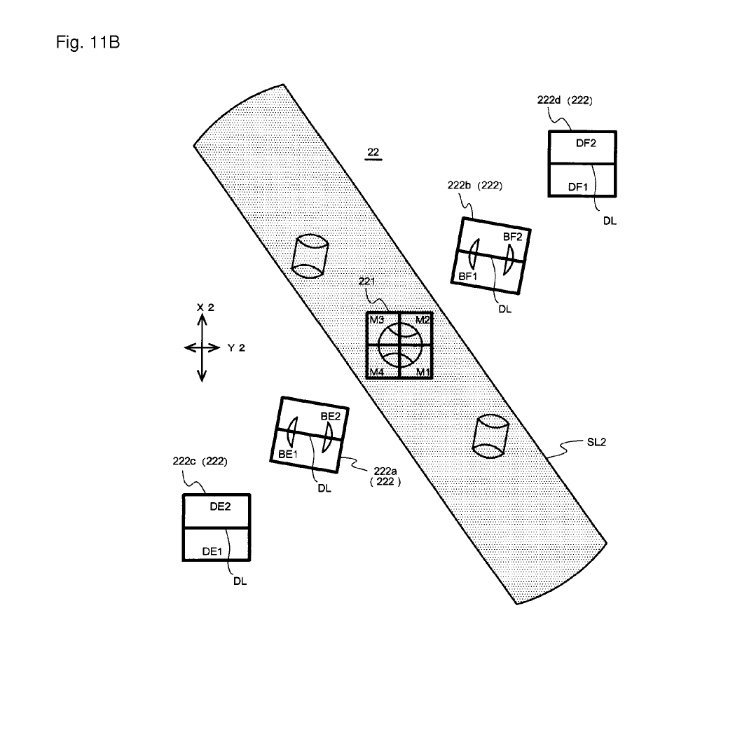

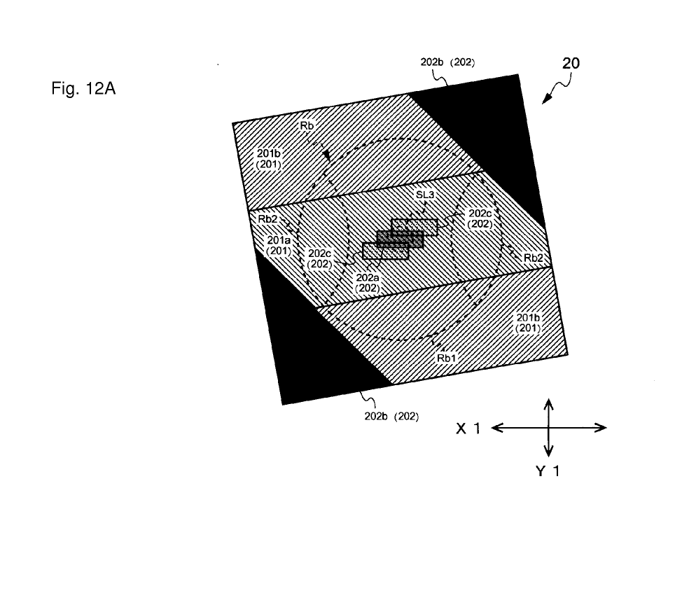

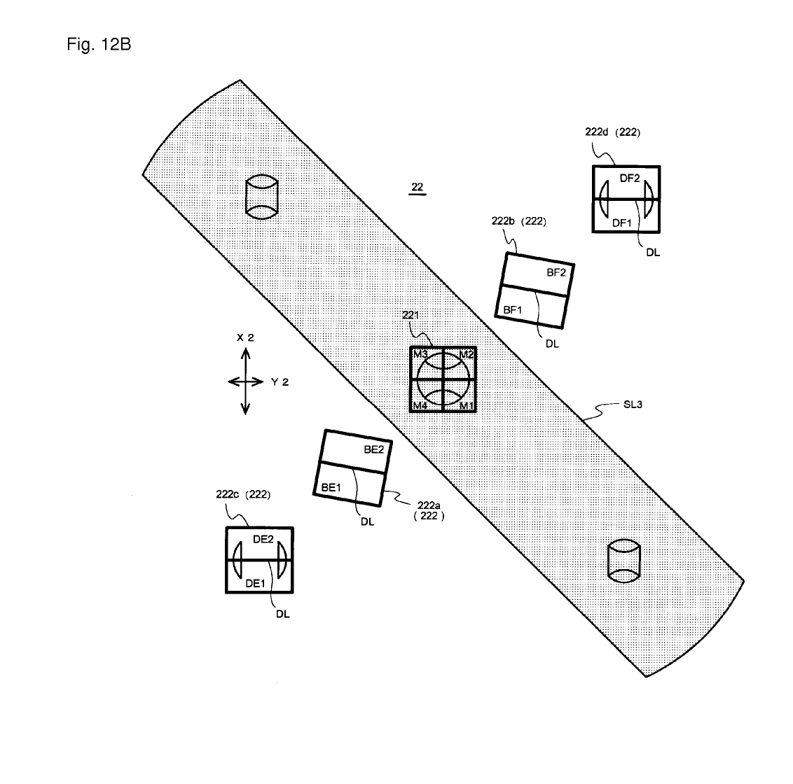

The first diffracting portion 201a guides the 0th order diffracted light of return lights Ra and Rb to the main light-receiving unit 221 of the photodetector 22 using these diffraction grooves. In addition, it causes the ±1st order diffracted lights of the return lights Ra and Rb to entire the regions other than the respective light-receiving planes of the main light-receiving unit 221 and auxiliary light-receiving units 222 of the photodetector 22 (see FIG. 11B and FIG. 12B described later).

The second diffracting portions 201b guide the 0th order diffracted light of return lights Ra and Rb to the main light-receiving unit 221 of the photodetector 22 using these diffraction grooves. Furthermore, they respectively guide the ±1st order diffracted lights of the return light Ra of the BD laser light to the first and second auxiliary light-receiving units 222a and 222b of the photodetector 22. Moreover, they respectively guide the ±1st order diffracted lights of the return light Rb of the DVD laser light to the third and fourth auxiliary light-receiving units 222c and 222d of the photodetectors 22 (see FIG. 11B and FIG. 12B). The two second diffracting portions 201b are disposed in parallel sandwiching the first diffracting portion 201a in the direction inclined in the leftward rotation (counterclockwise) from the direction Y1 orthogonal to the direction X1 in FIG. 5.

The light-blocking portions 202 are provided in order to block stray light reflected from a recording layer other than the recording layer on which the laser light is focused in an optical disc D with a multilayer configuration. These light-blocking portions 202 are configured by combining three types of light-blocking patterns 202a, 202b, and 202c that block light of wavelengths different from each other. The first and second light-blocking patterns 202a and 202b are provided in order to block stray light reflected from a BD with a multilayer configuration, while the third light-blocking pattern 202c is provided in order to block stray light reflected from a DVD with a multilayer configuration.

The first light-blocking pattern 202a is provided, in a three-layer BDXL, for example, in order to block the first stray light SL1 reflected from a recording layer (e.g., recording layer L0) provided on the side farther from the light-entering surface of the BDXL than the recording layer (e.g., recording layer L1) where information is being read or written (see FIG. 3B). The first stray light SL1 is thus prevented from entering the photodetector 22. In addition, the first light-blocking pattern 202a is a rectangular or substantially rectangular light-blocking pattern provided within the first diffracting portion 201a. The width in the Y1 direction of the first light-blocking pattern 202a is preferably at least the size in the Y1 direction of the first stray light SL1 on the light-entering surface of the hologram element 20. Furthermore, the longitudinal direction of the first light-blocking pattern 202a is substantially parallel to the X1 direction, which corresponds to the lens shift direction X of the second objective lens 18b. Accordingly, the first stray light SL1 is prevented from entering the photodetector 22 by the first light-blocking pattern 202a even if the first stray light SL1 moves as the second objective lens 18b shifts.

The width in the X1 direction of the first light-blocking pattern 202a is set to be smaller than the minimum distance in the X1 direction between the edge of one second return light Ra2 (for example, the right edge of the second return light Ra2 on the left side in FIG. 3A) and the edge of the other second return light Ra2 (for example, the left edge of the second return light Ra2 on the right side in FIG. 3A). Furthermore, it is desirable that this width be set to a length which is at least short enough to prevent the first light-blocking pattern 202a from overlapping the second return lights Ra2 even if the second objective lens 18b shifts.

The second light-blocking pattern 202b is provided, in a three-layer BDXL, for example, in order to block the second stray light SL2 entering from a recording layer (e.g., recording layer L2) provided on the side closer to the light-entering surface of the BDXL than the recording layer (e.g., recording layer L1) where information is being read or written (see FIG. 3B). Thus, the second stray light SL2 is prevented from entering at least the auxiliary light-receiving units 222 (especially the first and second auxiliary light-receiving units 222a and 222b) of the photodetector 22. The second light-blocking pattern 202b, as shown in FIG. 5, is provided in regions on both sides of the return lights Ra and Rb sandwiching the return lights so as not to overlap the return lights Ra and Rb in a plan view seen from the direction in which the return lights Ra and Rb enter the hologram element 20.

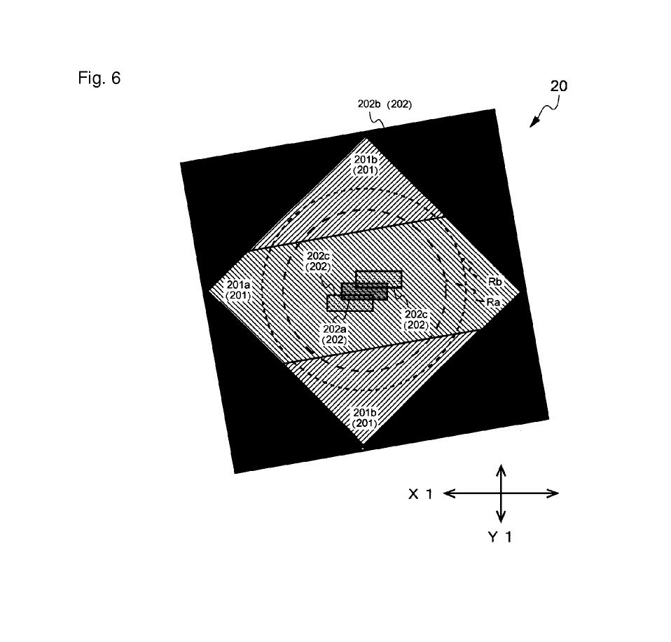

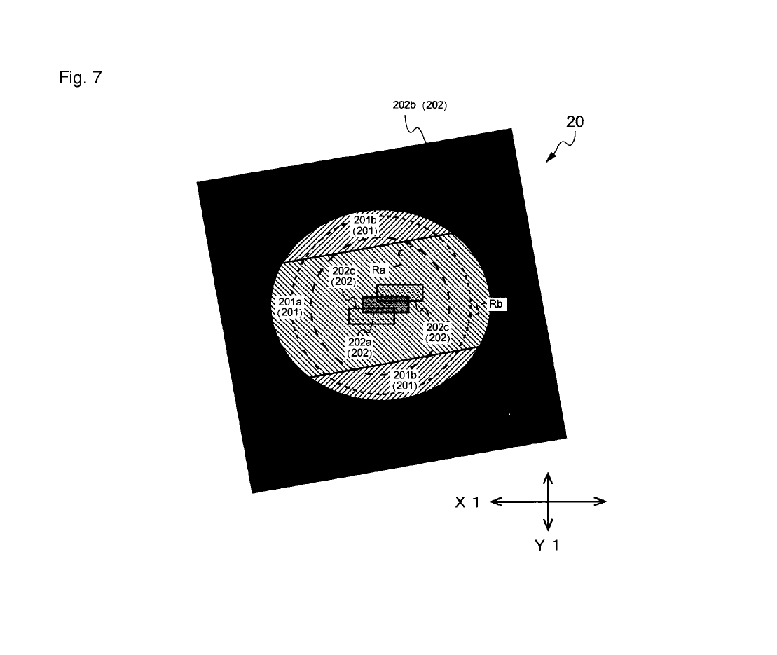

Note that the shape of the second light-blocking pattern 202b is not limited to the example of FIG. 5. FIGS. 6 and 7 are schematic plan views showing other exemplary configurations of the hologram element of the present preferred embodiment. The second light-blocking pattern 202b may be provided in the outside region of a quadrangular, circular, or elliptical-shaped area in a plan view seen from the direction in which the return lights Ra and Rb enter the hologram element 20. Moreover, the second light-blocking pattern 202b may be provided in the outside region of an area having a parallelogram (such as a square or rhombus) shape in which one of the two diagonal lines is parallel or substantially parallel to the direction X1, which corresponds to the lens shift direction X as shown in FIG. 6. Alternatively, it may be provided in the outside region of an elliptical area whose major axis is parallel or substantially parallel to the direction X1, which corresponds to the lens shift direction X as shown in FIG. 7.

The third light-blocking pattern 202c is provided, in a two-layer DVD, for example, in order to block the third stray light SL3 reflected from a recording layer (e.g., recording layer L1) provided on the side farther from the light-entering surface of the DVD than the recording layer (e.g., recording layer L0) where information is being read or written (see FIG. 4B). Thus, the third stray light SL3 is prevented from entering at least the auxiliary light-receiving units 222 (especially the third and fourth auxiliary light-receiving units 222c and 222d) of the photodetector 22. In addition, the third light-blocking pattern 202c includes two substantially rectangular light-blocking patterns provided within the first diffracting portion 201a. The longitudinal direction of the two third light-blocking patterns 202c is parallel or substantially parallel to the X1 direction, which corresponds to the lens shift direction X of the first objective lens 18a. Accordingly, the third stray light SL3 can be kept from entering the two auxiliary light-receiving units 222c and 222d by the third light-blocking patterns 202c even if the third stray light SL3 moves accompanying the lens shift of the first objective lens 18a.

In the present preferred embodiment, the third light-blocking patterns 202c preferably have the same or substantially the same shape and size as the first light-blocking pattern 202a, but the applicable scope of the present invention is not limited to this configuration. The widths of the direction X1 and the direction Y1 of the third light-blocking patterns 202c need only be dimensions sufficient to be able to block the third stray light SL3 entering at least the auxiliary light-receiving units 202 (especially the third and fourth light-receiving units 202c and 202d) using the third light-blocking patterns 202c.

The first through third light-blocking patterns 202a through 202c are preferably made using dielectric materials such as metals (such as Al). Furthermore, the first through third light-blocking patterns 202a through 202c can be formed by methods such as coating on or vapor-depositing the materials or pasting them on as sheets. Alternatively, the portions of the hologram element 20 corresponding to the first through third light-blocking patterns 202a through 202c may be formed using the materials.

Moreover, the respective light blocking rates of the first through third light-blocking patterns 202a through 202c differ from each other and also exhibit wavelength dependence. The first light-blocking pattern 202a, for example, transmits (a light blocking rate of 0%) light at a wavelength corresponding to DVD laser light (e.g., about 661 nm) and exhibits a light blocking rate of about 70% or more for light at a wavelength corresponding to BD laser light (e.g., about 405 nm). In addition, the second light-blocking pattern 202b nearly completely blocks (a light blocking rate of about 100%, for example) light of various wavelengths corresponding to DVD and BD laser light. The third light-blocking patterns 202c, for example, exhibit a light blocking rate of about 50% or more for light at a wavelength corresponding to DVD laser light and transmit (a light blocking rate of 0%) light at a wavelength corresponding to BD laser light.

Thus, the respective light blocking rates of the first through third light-blocking patterns 202a through 202c vary according to the wavelength of the light entering the hologram element 20. This makes it possible to block the light entering the hologram element 20 by the light-blocking pattern corresponding to the wavelength of the stray light but to avoid the blocking by the other light-blocking patterns which correspond to other wavelengths of light, for example. Accordingly, it is possible to prevent the light required to generate the tracking error signal TE from being blocked by the other light-blocking patterns.

Furthermore, the respective light blocking rates of the first through third light-blocking patterns 202a through 202c differ from each other. For example, the first and third light-blocking patterns 202a and 202c are provided in the region where return lights Ra and Rb enter. For this reason, the light-blocking rates of the first and third light-blocking patterns 202a and 202c are set sufficiently low that the offset component arising due to the first stray light SL1 and the third stray light SL3 does not affect the tracking error signal TE. On the other hand, the second light-blocking pattern 202b is provided in the region where the return lights Ra and Rb do not enter. For this reason, the light-blocking rate of the second light-blocking pattern 202b is set at about 100%. Accordingly, it is possible to inhibit blocking by the light-blocking patterns 202a, 202b, and 202c of the light required to generate the tracking error signal TE.

Next, the photodetector 22 will be described in detail. FIG. 8 is a schematic plan view showing the configuration of the photodetector of the present preferred embodiment. The photodetector 22 preferably includes the main light-receiving unit 221 and four auxiliary light-receiving units 222 of identical shape and size as shown in FIG. 8. The four auxiliary light-receiving units 222 sandwich the main light-receiving unit 221 and are disposed so as to be aligned in the direction inclined to the right rotation (clockwise) with respect to the direction X2, which corresponds to the lens shift direction X. Note that the direction X2 is the direction that the light spot located on the light-receiving plane of the photodetector 22 moves when the first or second objective lens 18a or 18b is moved (shifted) in the tracking direction (lens shift direction).

The main light-receiving unit 221 receives each 0th order diffracted light that enters from the first diffracting portion 201a and the second diffracting portions 201b and generates a main light-receiving unit signal based on the received light. The main light-receiving unit 221 includes four sub-regions M1 through M4 obtained by dividing the substantially square light-receiving region in equal halves in the X2 direction and equal halves in its orthogonal Y2 direction.

The auxiliary light-receiving units 222 receive the ±1st order diffracted lights that enter from the second diffracting portions 201b and generate an auxiliary light-receiving unit signal based on the received light. Note that this auxiliary light-receiving unit signal expresses the offset component arising due to the lens shift of the first or second objective lens 18a or 18b. The auxiliary light-receiving units 222 preferably include the first auxiliary light-receiving unit 222a, second auxiliary light-receiving unit 222b, third auxiliary light-receiving unit 222c, and fourth auxiliary light-receiving unit 222d.

The first auxiliary light-receiving unit 222a and the second auxiliary light-receiving unit 222b receive the ±1st order diffracted lights of the return light Ra of BD laser light. The first auxiliary light-receiving unit 222a includes two sub-regions BE1 and BE2 obtained by evenly dividing the substantially square-shaped light-receiving region with a dividing line DL, while the second auxiliary light-receiving unit 222b has two sub-regions BF1 and BF2 obtained by evenly dividing the substantially square-shaped light-receiving region with a dividing line DL. Moreover, the first auxiliary light-receiving unit 222a and the second auxiliary light-receiving unit 222b are each disposed so as to be inclined toward the right rotation (clockwise) with respect to the direction X2 in FIG. 8. This is because the second objective lens 18b is disposed at a position offset in the tangential direction from the datum plane A parallel to the direction perpendicular and also radial to the main plane of the optical disc D (see FIG. 2).

The third auxiliary light-receiving unit 222c and the fourth auxiliary light-receiving unit 222d receive the ±1st order diffracted lights of the return light Rb of DVD laser light. The third auxiliary light-receiving unit 222c includes two sub-regions DE1 and DE2 obtained by evenly dividing the substantially square-shaped light-receiving region with a dividing line DL, while the fourth auxiliary light-receiving unit 222d has two sub-regions DF1 and DF2 obtained by evenly dividing the substantially square-shaped light-receiving region with a dividing line DL.

As shown in FIG. 8, the dividing lines DL of the various auxiliary light-receiving units 222a through 222d are located at positions that respectively bisect the ±1st order diffracted lights that enter from the second diffracting portions 201b when the first or second objective lens 18a or 18b is not shifted. Therefore, when the optical disc D is a BD, it is possible to obtain a tracking error signal TE that cancels the effect of the offset component due to lens shift of the second objective lens 18b by using Equation (1) below:

TE=MP−k*SP=((SM1+SM2)−(SM3+SM4))−k*((SBE1−SBE2)+(SBF1−SBF2)) (1)

In addition, when the optical disc D is a DVD, it is possible to obtain a tracking error signal TE that cancels the effect of the offset component due to lens shift of the first objective lens 18a by using Equation (2) below:

TE=MP−k*SP=((SM1+SM2)−(SM3+SM4))−k*((SDE1−SDE2)+(SDF1−SDF2)) (2)

Note that k in Equations (1) and (2) is a coefficient. Furthermore, MP is the main light-receiving unit signal generated by the main light-receiving unit 221, while SP is the auxiliary light-receiving unit signal generated by the auxiliary light-receiving units 222. Moreover, in Equations (1) and (2), the various photoelectric conversion signals output from the respective sub-regions of the main light-receiving unit 221 and the four auxiliary light-receiving units 222 are indicated by adding “S” in front of the name of each of the sub-regions.

In Equations (1) and (2), the difference between the main light-receiving unit signal MP and the appropriately amplified auxiliary light-receiving unit signal SP is determined, thus obtaining a tracking error signal TE through which the effect of the offset component due to lens shift of the first objective lens 18a or the second objective lens 18b is canceled.

Here, in types of optical discs D that have a plurality of recording layers (such as three-layer BDXLs and two-layer DVDs), stray light reflected from layer(s) other than the recording layer that is performing the read or write of information also enters the main light-receiving unit 221 and the auxiliary light-receiving units 222. Therefore, an offset component arising due to stray light is generated in the tracking error signal TE. When this offset component is generated in an auxiliary light-receiving unit signal SP, in particular, the effect of the lens shift offset component can no longer be canceled out accurately from the tracking error signal TE. In order to prevent such stray light effect, the hologram element 20 is provided with the light-blocking portions 202 in the present preferred embodiment. The effect of providing the light-blocking portions 202 in the hologram element 20 will be described below by citing Comparative Example 1, Comparative Example 2, Working Example 1, and Working Example 2, in that order.

### Comparative Example 1

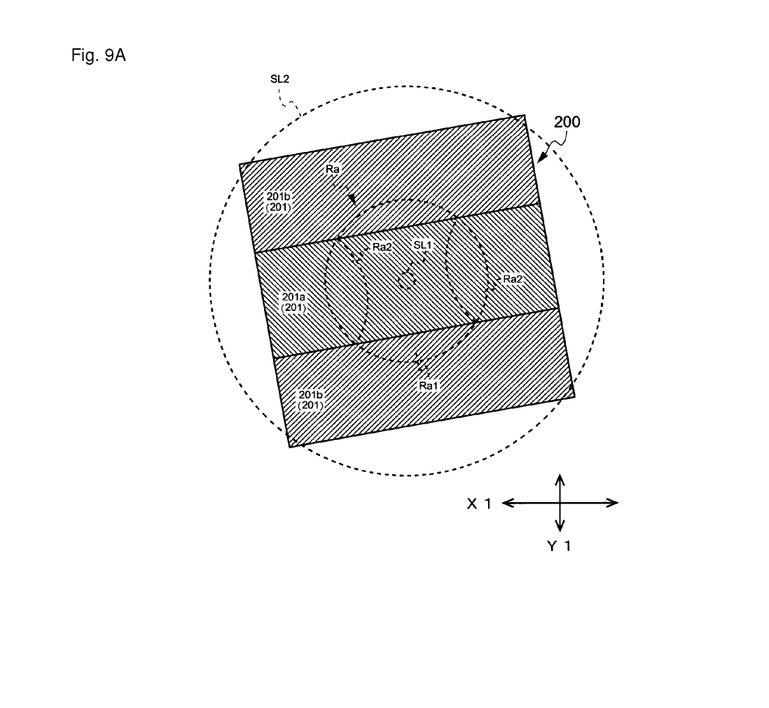

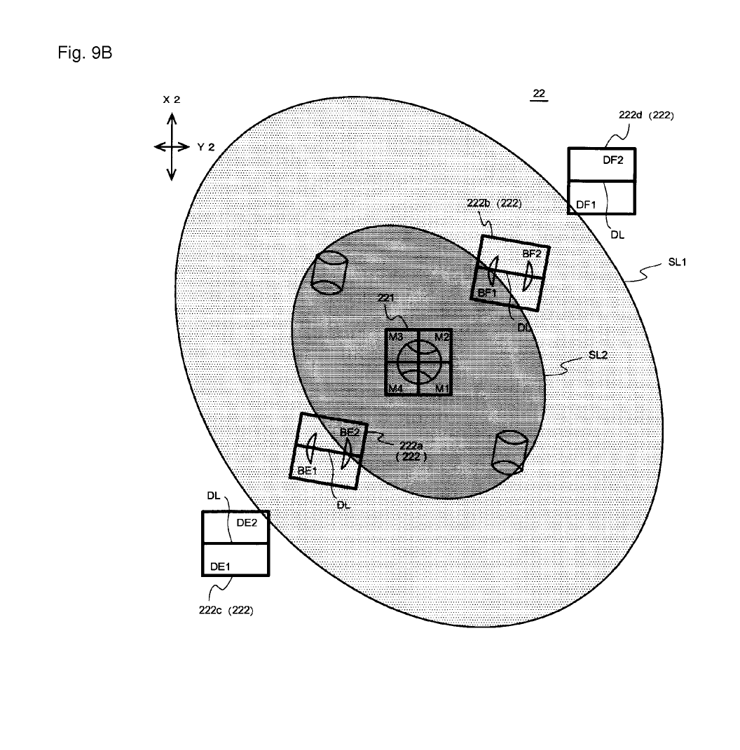

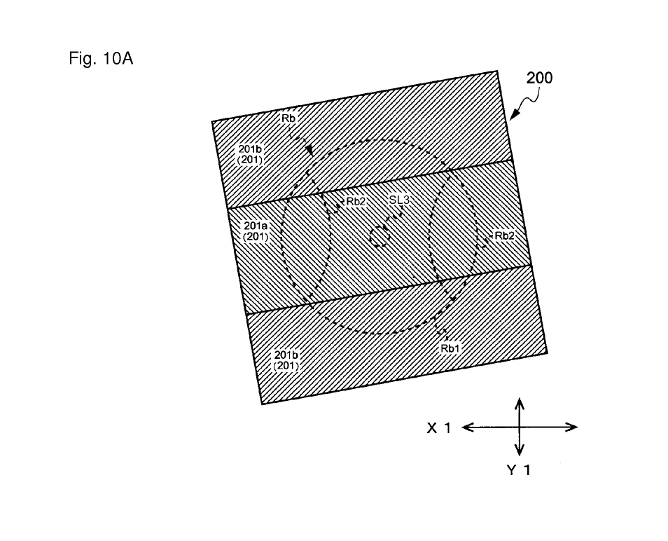

FIG. 9A is a schematic plan view showing the hologram element of Comparative Example 1. Furthermore, FIG. 9B is a schematic plan view showing the light reception pattern of the photodetector for BDXLs of the three-layer type in Comparative Example 1. The hologram element 200 of Comparative Example 1 is the same as the hologram element 20 of the present preferred embodiment, except for not having any light-blocking portion 202. Note that in FIG. 9A, the return light Ra, the first stray light SL1, and the second stray light SL2 that enter the hologram element 200 are indicated by dotted lines. Moreover, FIG. 9B is a diagram that envisions a configuration in which BD laser light is focused on the recording layer L1 of a three-layer BDXL (see FIG. 3B).

In Comparative Example 1, as shown in FIG. 9A and FIG. 9B, the first stray light SL1 reflected from the recording layer L0 is diffracted by the first diffracting portion 201a, and this diffracted light enters the region that includes the light-receiving plane of the main light-receiving unit 221 and the light-receiving planes of the auxiliary light-receiving units 222 of the photodetector 22. In addition, the second stray light SL2 reflected from the recording layer L2 is diffracted by the first diffracting portion 201a and the two second diffracting portions 201b. This diffracted light enters the region that includes the entire light-receiving plane of the main light-receiving unit 221 and at least a portion of the respective light-receiving planes of the first and second auxiliary light-receiving units 222a and 222b of the photodetector 22. Note that the diffracted light of the first stray light SL1 and the second stray light SL2 is received at the photodetector 22 after passing through the cylindrical lens 21, so the entering regions thereof have an elliptical shape.

Thus, in Comparative Example 1, the auxiliary light-receiving units 222 (especially the first and second auxiliary light-receiving units 222a and 222b) receive the diffracted light of the first stray light SL1 and the second stray light SL2. Therefore, in the comparative example, the offset components arising due to the first stray light SL1 and the second stray light SL2 are generated in the auxiliary light-receiving unit signals SP, so the effect of the offset component due to the lens shift of the second objective lens 18b can no longer be canceled out accurately from the tracking error signal TE.

### Comparative Example 2

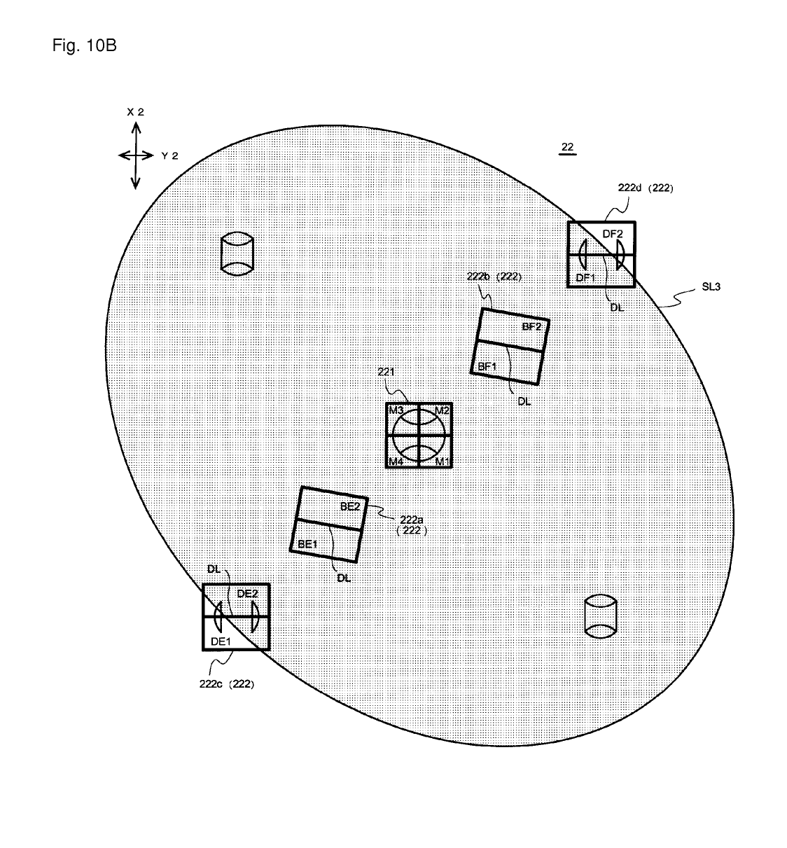

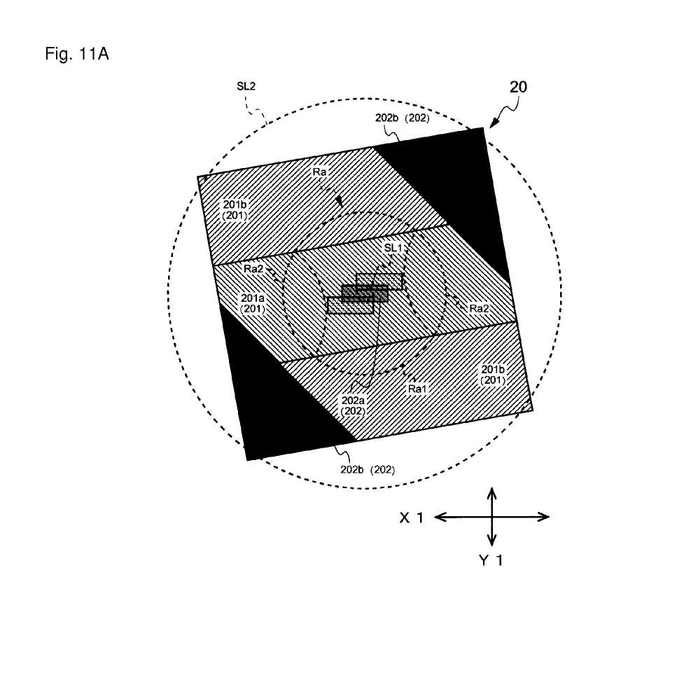

FIG. 10A is a schematic plan view showing the hologram element of Comparative Example 2. Furthermore, FIG. 10B is a schematic plan view showing the light reception pattern of the photodetector for DVDs of the two-layer type in Comparative Example 2. The hologram element 200 of Comparative Example 2 is the same as the hologram element 20 of the present preferred embodiment, except for not having any light-blocking portion 202. Note that in FIG. 10A, the return light Rb and the third stray light SL3 that enter the hologram element 200 are indicated by dotted lines. Moreover, FIG. 10B is a diagram that envisions a configuration in which DVD laser light is focused on the recording layer L0 of a two-layer DVD (see FIG. 4B).

In Comparative Example 2, as shown in FIG. 10A and FIG. 10B, the third stray light SL3 reflected from the recording layer L0 is diffracted by the first diffracting portion 201a, and this diffracted light enters the region that includes the entire light-receiving plane of the main light-receiving unit 221, the entire light-receiving planes of the first and second auxiliary light-receiving units 222a and 222b, and at least a portion of the respective light-receiving planes of the third and fourth auxiliary light-receiving units 222c and 222d of the photodetector 22. Note that the diffracted light of the third stray light SL3 is received at the photodetector 22 after passing through the cylindrical lens 21, so the entering region thereof has an elliptical shape.

Thus, in Comparative Example 2, the auxiliary light-receiving units 222 (especially the third and fourth auxiliary light-receiving units 222c and 222d) receive the diffracted light of the third stray light SL3. Therefore, in Comparative Example 2, the offset component arising due to the third stray light SL3 is generated in the auxiliary light-receiving unit signals SP, so the effect of the offset component due to the lens shift of the first objective lens 18a can no longer be canceled out accurately from the tracking error signal TE.

### Working Example 1

In contrast, the hologram element 20 of the present preferred embodiment is provided with the light-blocking portions 202 to block the first through third stray lights SL1 through SL3. Because of this, these stray lights are prevented from entering the various light-receiving units 221 and 222 of the photodetector 22. FIG. 11A is a schematic plan view showing the hologram element of Working Example 1. FIG. 11B is a schematic plan view showing the light reception pattern of the photodetector for BDXLs of the three-layer type in Working Example 1 of the present preferred embodiment. Note that FIG. 11A and FIG. 11B are diagrams that envision a configuration in which BD laser light is focused on the recording layers L1 of a three-layer BDXL (see FIG. 3B).

In Working Example 1, the first stray light SL1 reflected from the recording layer L0 is completely blocked by the first light-blocking pattern 202a, and a portion of the second stray light SL2 reflected from the recording layer L2 is blocked by the second light-blocking pattern 202b as shown in FIG. 11A. Therefore, the first stray light SL1 does not enter the photodetector 22 as shown in FIG. 11B. In addition, the diffracted light of the remaining portion of the second stray light SL2 enters the main light-receiving unit 221 of the photodetector 22, but at the least it does not enter the auxiliary light-receiving units 222 (particularly the first and second auxiliary light-receiving units 222a and 222b). Accordingly, the generation in the tracking error signal TE of the offset components arising due to the first stray light SL1 and the second stray light SL2 is prevented. Consequently, it is possible to prevent the generation of the offset components arising due to the first stray light SL1 and the second stray light SL2 and therefore to obtain a good tracking error signal TE from which the offset component arising due to the lens shift of the second objective lens 18b has been removed. Furthermore, the main light-receiving unit 221 does not receive the first stray light SL1, so the error of the tracking error signal TE is further reduced.

### Working Example 2

FIG. 12A is a schematic plan view showing the hologram element of Working Example 2. FIG. 12B is a schematic plan view showing the light reception pattern of the photodetector for DVDs of the two-layer type in Working Example 2 of the present preferred embodiment. Note that FIG. 12B is a diagram that envisions a configuration in which DVD laser light is focused on the recording layer L0 of a two-layer DVD (see FIG. 4B).

In Working Example 2, a portion of the third stray light SL3 reflected from the recording layer L1 is blocked by the third light-blocking patterns 202c as shown in FIG. 12A. For this reason, the diffracted light of the remaining portion of the third stray light SL3 enters the main light-receiving unit 221 of the photodetector 22, but at the least it does not enter the auxiliary light-receiving units 222 (particularly the third and fourth auxiliary light-receiving units 222c and 222d) as shown in FIG. 12B. Accordingly, the generation in the tracking error signal TE of the offset component arising due to the third stray light SL3 is prevented. Consequently, it is possible to prevent the generation of the offset component arising due to the third stray light SL3 and therefore to obtain a good tracking error signal TE from which the offset component arising due to the lens shift of the first objective lens 18a has been removed.

The present invention was described above based on preferred embodiments. A person skilled in the art should understand that the preferred embodiments are non-limiting examples and that various modifications of the combination of the individual constituent elements and processes are possible and are within the scope of the present invention.

For instance, configurations to prevent the effects of stray light generated by three-layer BDXLs and two-layer DVDs were described above according to a preferred embodiment of the present invention. However, the applicable scope of the present invention is not limited to these configurations. The present invention can also be applied to optical discs that have a plurality of recording layers (such as BDs and DVDs of a two-layer type and BDXLs with three or more layers).

Moreover, the configurations (diffraction patterns) of the various diffracting portions 201 of the hologram element 20 of the preferred embodiments are merely examples, and the configurations thereof can be modified appropriately. For example, the preferred embodiments are preferably configured such that ±1st order diffracted lights of the light that has entered the second diffracting portions 201b of the hologram element 20 are respectively received at the individual auxiliary light-receiving units 222 of the photodetector 22, but the applicable scope of the present invention is not limited to this configuration. For instance, a configuration is also possible in which one of the ±1st order diffracted lights of the return light Ra is received at least at one of the first and second auxiliary light-receiving units 222a and 222b of the photodetector 22. In addition, a configuration is also possible in which one of the ±1st order diffracted lights of the return light Rb is received at least at one of the third and fourth auxiliary light-receiving units 222c and 222d of the photodetector 22.

Furthermore, the configurations of the various light-receiving units 221 and 222 of the photodetector 22 and the light-receiving planes thereof in the preferred embodiments are merely examples, and their configurations can be modified appropriately. For example, the preferred embodiments are preferably configured such that the various auxiliary light-receiving units 222 sandwich the main light-receiving unit 221 and are disposed in an alignment in a direction inclined with respect to the direction X2, which corresponds to the lens shift direction X. However, the applicable scope of the present invention is not limited to this configuration. For instance, a configuration is also possible in which the main light-receiving unit 221 and the various auxiliary light-receiving units 222 are disposed so as to be aligned in the direction X2.

In addition, the preferred embodiments are preferably configured such that the first objective lens 18a and the second objective lens 18b are disposed in a direction tangential to the optical disc D (FIG. 2). However, the applicable scope of the present invention is not limited to this configuration. For example, the present invention can also be applied to a case in which the first objective lens 18a and the second objective lens 18b are disposed in a radial direction, or the like. Furthermore, the present invention can also be applied when the number of objective lenses provided in the optical pickup 1 is a number other than two.

The types of optical discs D that are the target of the optical pickup 1 to which various preferred embodiments of the present invention are applied are not limited to those of the preferred embodiment shown above. Moreover, preferred embodiments of the present invention can also be applied to a case in which the optical pickup 1 handles three types of optical discs D (or in some cases, more than three types) as when it handles CDs in addition to DVDs and BDs, for example.

Preferred embodiments of the present invention are suitable for optical pickups which are compatible with a plurality of types of optical disc (such as BDs, DVDs, and CDs).

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. An optical pickup comprising:
a plurality of light sources which emit light of wavelengths that are different from each other;
an objective lens which focuses the light on an optical disc;
a diffractive optical element which includes a diffracting portion that diffracts return light reflected from a first recording layer of the optical disc where information is being read or written and a light-blocking portion that blocks stray light reflected from a second recording layer of the optical disc that is different from the first recording layer; and
a light-detecting unit which receives the diffracted light of the diffractive optical element and generates an output signal to generate a tracking error signal based on the diffracted light; wherein
the light-blocking portion includes a plurality of light-blocking patterns which block light of wavelengths that are different from each other so as to respectively permit colors of light different from the blocked wavelengths to pass there through; and
at least two of the plurality of light-blocking patterns are arranged at a central portion of the diffractive optical element.

2. The optical pickup according to claim 1, wherein the respective light-blocking rates of the plurality of light-blocking patterns vary according to the wavelength of light that enters the diffractive optical element.

3. The optical pickup according to claim 1, wherein the respective light-blocking rates of the plurality of light-blocking patterns are different from each other.

4. A disc device comprising the optical pickup according to claim 1.

5. The optical pickup according to claim 1, wherein one of the plurality of light-blocking patterns blocks blue light with a wavelength of about 405 nm and another one of the plurality of light-blocking patterns blocks red light with a wavelength of about 661 nm.

6. The optical pickup according to claim 1, wherein at least two of the plurality of light-blocking patterns are arranged to overlap one another.

7. The optical pickup according to claim 1, wherein the plurality of light-blocking patterns are rectangular shaped members which are elongated in a direction parallel to a lens shift direction of the objective lens.
